(19) United States
(12) Patent Application Publication
(10) Pub. No.: US 2025/0240648 A1
(43) Pub. Date: Jul. 24, 2025

(54) MODEL MANAGEMENT FOR CHANNEL STATE ESTIMATION AND FEEDBACK

(71) Applicant: QUALCOMM Incorporated, San Diego, CA (US)

(72) Inventors: Chenxi HAO, Beijing (CN); Yuwei REN, Beijing (CN); Taesang YOO, San Diego, CA (US); Hao XU, Beijing (CN); Ruiming ZHENG, Beijing (CN); Yu ZHANG, San Diego, CA (US); Rui HU, Beijing (CN); Wei XI, Beijing (CN)

(21) Appl. No.: 18/844,882

(22) PCT Filed: Apr. 28, 2022
(86) PCT No.: PCT/CN2022/089790

§ 371 Date: Sep. 6, 2024

(51) Int. Cl. H04W 24/02; H04B 7/06; H04W 24/10

(52) U.S. Cl. CPC H04W 24/02; H04B 7/0626; H04W 24/10

(57) ABSTRACT

Certain aspects of the present disclosure provide techniques for wireless communications. One aspect provides a method of wireless communications by a user equipment (UE), the method including receiving, from a network entity, a reference signal; processing the reference signal with a machine learning model to generate machine learning model output; and determining an action to take based on the machine learning model output and a model monitoring configuration.

### BACKGROUND

### Field of the Disclosure

Aspects of the present disclosure relate to wireless communications, and more particularly, to techniques for managing models for channel state estimation and feedback.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving, from a network entity, a reference signal; processing the reference signal with a machine learning model to generate machine learning model output; and determining an action to take based on the machine learning model output and a model monitoring configuration.

Another aspect provides a method of wireless communications by a network entity. The method includes sending, to a user equipment, a model monitoring configuration; sending, to the user equipment, a reference signal; and receiving, from the user equipment, based on the reference signal, one of a model variance indication or a model failure indication.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of monitoring a machine learning model performance over time.

FIG. 6 depicts an example of a model monitoring framework.

FIG. 7 depicts an example of a model monitoring configuration for an inferencing mode.

FIG. 8 depicts an example of a model monitoring configuration for a monitoring mode.

FIG. 9 depicts an example of a model monitoring configuration for an inferencing and monitoring mode.

FIGS. 10A-10D depict various examples of model monitoring mode switching.

FIGS. 11A-11B depicts example method for counting model variance events.

FIG. 12 depicts aspects related to reporting model variance events and model failures, such as when a user equipment is operating in a monitoring mode.

FIG. 13 depicts an example of using low-density CSI-RS for machine learning model-based channel estimation.

FIG. 14 depicts an example of paired CSI-RS resources between a first (target) resource set and a second (reference) resource set.

FIG. 15 depicts an example of a model monitoring method for a machine learning-based channel estimation model.

FIG. 16 depicts a method for wireless communications.

FIG. 17 depicts another method for wireless communications.

FIG. 18 depicts aspects of an example communications device.

FIG. 19 depicts aspects of another example communications device.

### DETAILED DESCRIPTION

Aspects of the present disclosure provide apparatuses, methods, processing systems, and computer-readable mediums for managing models for channel state estimation and feedback.

Understanding the channel state between devices communicating in a wireless communications system is an important aspect of improving the performance of wireless communications. Conventionally, many techniques have been employed for measuring the channel state and reporting feedback so that performance can be improved. However, such conventional techniques are often relatively slow, power hungry, and static in approach.

Machine learning represents an opportunity to improve upon many conventional techniques for measuring channel state and reporting feedback. For example, machine learning models may reduce the number of resource elements needed for estimating a channel state, and improve the estimates of values used in reporting the channel state. However, because the wireless environment tends to be extremely dynamic, it is important to be able to monitor the performance of the machine learning models implementing critical channel state measuring and feedback procedures and to take remedial action if, for example, a model starts to underperform. Such remedial action may include, for example, falling back to a baseline model (e.g., a non-machine-learning model) to perform various aspects until the machine learning model can be reconfigured to maintain optimal performance.

Aspects described herein relate generally to methods for monitoring performance and detecting failures related to machine learning models used for channel state measuring and feedback procedures. In various aspects, a network may configure and/or a user equipment may implement various modes for monitoring model performance. In some aspects, model performance is monitored by determining output variance events and for reporting such variance events to a network and/or using such variance events to determine when a model has become unreliable or “failed.” In some aspects, a model variance event may be an out-of-distribution (OOD) event, which generally refers to a machine learning model generating an uncertain output based on an input that differs from its training data.

By actively monitoring the performance of and detecting failures with respect to machine learning models, with or without the assistance of the network, aspects described herein enable the benefits of machine learning models, such as faster, more power efficient, and more accurate operation, while mitigating simultaneously against the possibility of machine learning model performance degradation over time. Such degradation may be caused, for example, by a machine learning model being exposed to new environments and new conditions that were not initially accounted for during training of the machine learning model. In the context of various examples described herein, that may include a user equipment performing channel estimation and predicting channel state information feedback using machine learning models in a radio environment different from the environments considered during training of the models. Detecting such degradations allow for reconfiguring (e.g., retraining) the machine learning models to maintain state of the art performance, and for falling back to baseline models in the meantime.

Thus, aspects described herein, which enable robust use of machine learning models for channel state measuring and feedback procedures, enhance wireless communications performance generally, and more specifically through reduced power use, increased battery life, improved spectral efficiency, reduced latency, and decreased network overhead, to name a few technical improvements.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

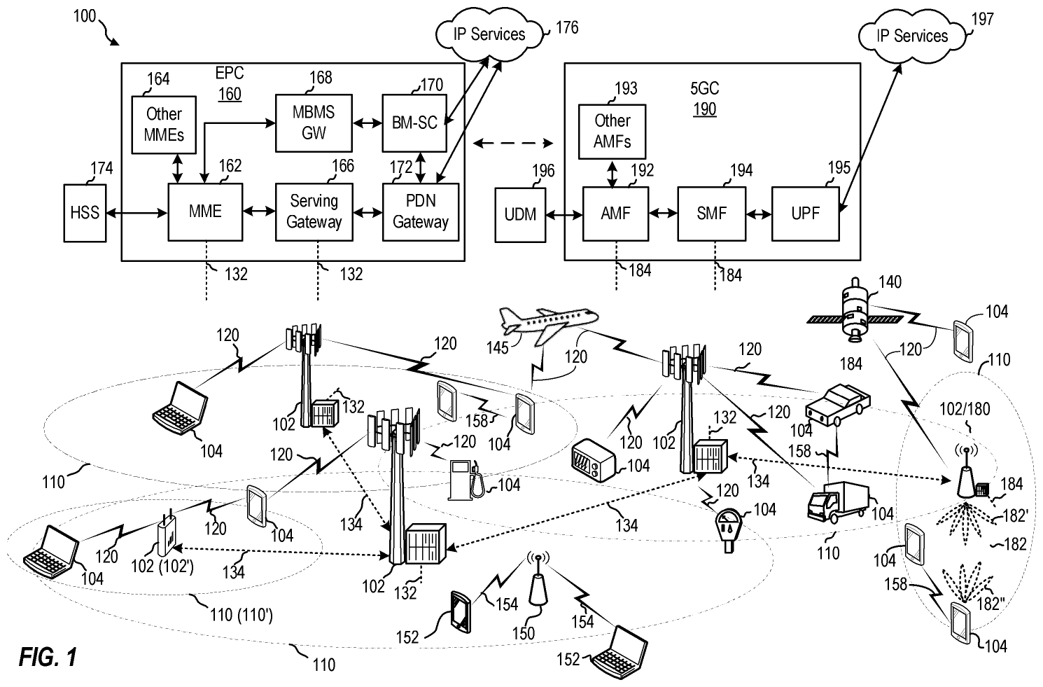

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

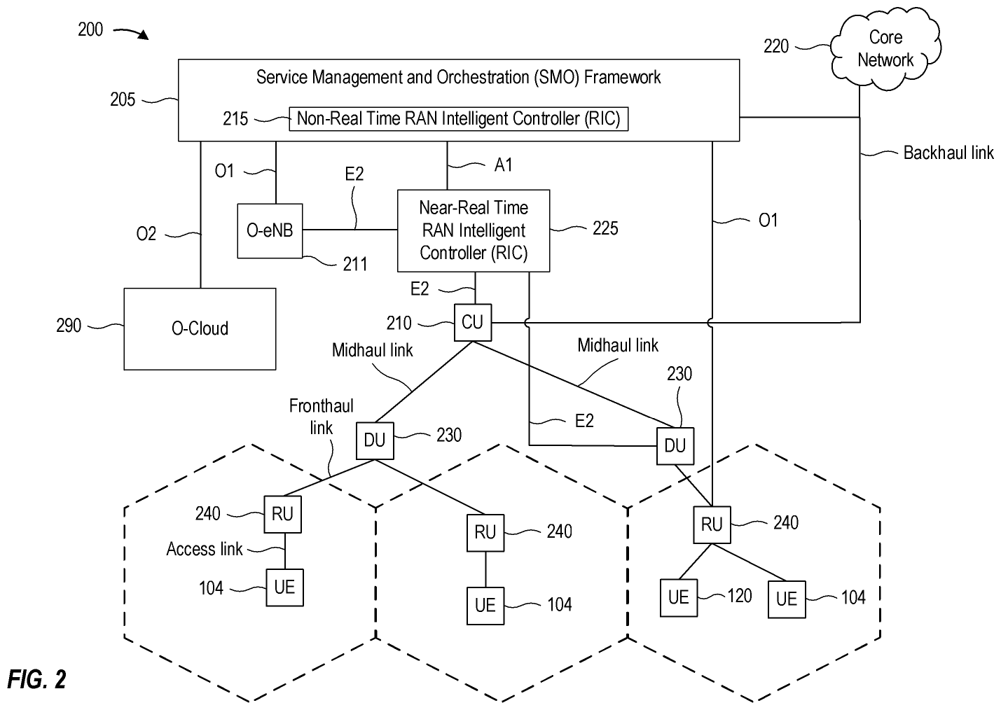

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

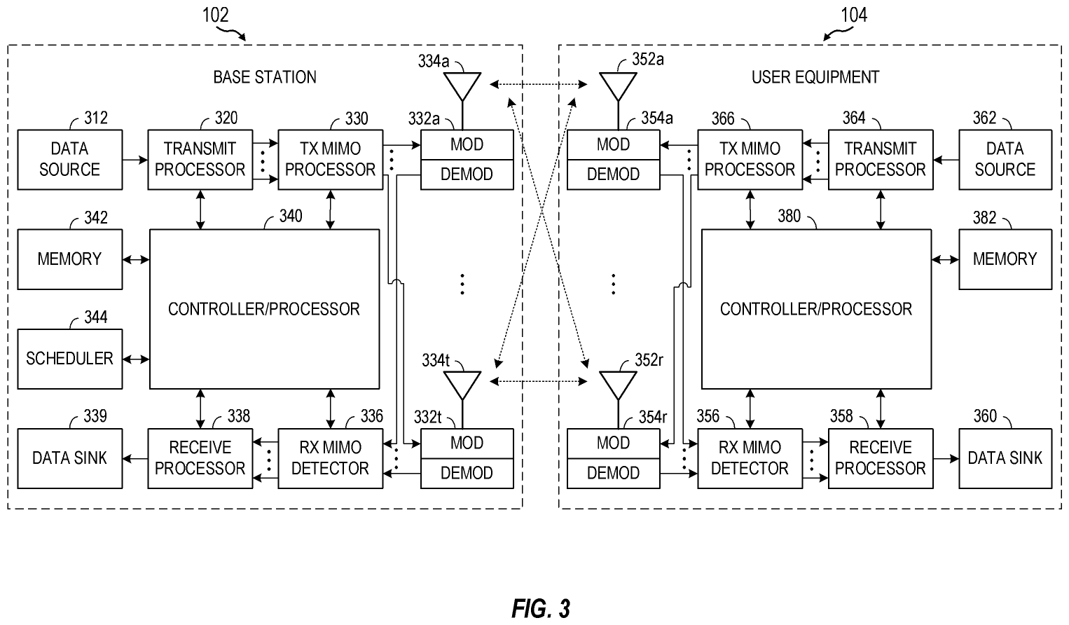

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

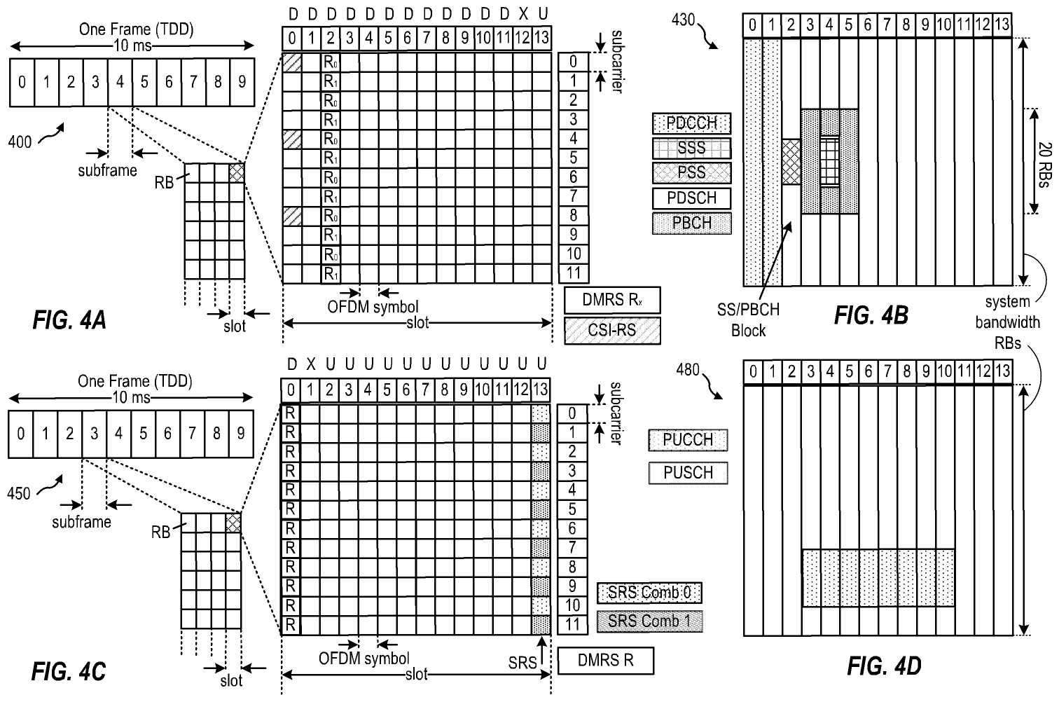

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Managing Models for Channel State Estimation and Feedback

Conventionally, several techniques have been used to help determine the channel state between wireless communications devices so that those devices can optimize their wireless communications configurations (e.g., choosing the best beam for transmitting and receiving data). For example, a channel state information reference signal (CSI-RS) may be transmitted by one device and measured by another device in order to estimate channel state and to provide channel state information (CSI) feedback that is useful for optimizing wireless communications between the two devices.

However, owing to the growing complexity and capability of wireless communication devices, such as those capable of transmitting and receiving over multiple input and output antenna ports (e.g., implementing multiple-input multiple-output (MIMO) techniques), conventional techniques may require significant processing power and time, which reduces the performance of both the devices and the overall wireless communications network. These technical problems are exacerbated by the typical use cases and environments for wireless communications, which are often dynamic. In other words, because channel state is frequently changing, channel estimation and feedback procedures are often performed frequently, leading to high power use and significant network overhead (e.g., in terms of time and frequency resources dedicated to channel estimation) for the wireless communication system. One method of mitigating such issues is to implement machine learning models that may more accurately, and more efficiently, perform various functions related to channel state estimation and feedback.

For example, conventional wireless communication systems may multiplex Nₜ ports on Nₜ resource elements of each resource block using, for example, time division multiplexing (TDM), code division multiplexing (CDM), and/or frequency division multiplexing (FDM). Such systems may generally implement a resource block density between 0.5 and 1, such that the resource elements are transmitted in every other or every single resource block. By contrast, a machine learning model deployed by a transmitting device (e.g., a base station) may be trained to perform multiplexing of Nₜ ports on L resource elements of each resource block, where L<Nₜ, which thus reduces the number of resource elements needed for channel estimation-leaving more resource elements available for data transmission. In addition to reducing the number of resource elements needed for channel estimation, which reduces power and enhances resource utilization, such models may operate with reduced resource block density (e.g., below 0.5) and non-uniform resource block patterns may also be implemented, which further improve upon the aforementioned benefits. At a receiving device (e.g., a user equipment) side, a machine learning-based channel estimator may be trained to recover the full channel, e.g., Nₜ ports on all resource blocks while receiving the reduced number of resource, L. In various aspects, CSI-RS multiplexing models at transmitter side and receiver side may be trained jointly or sequentially.

As another example, a conventional CSI reporting configuration may rely on a precoding matrix indicator (PMI) searching algorithm as well as a PMI codebook for determining and reporting the best PMI codewords (e.g., CSI feedback) to a network. However, a machine learning-based model, such as an encoder and decoder, may be trained to generate CSI feedback directly, which obviates the need for the PMI searching algorithm (replaced by the encoder) and the PMI codebook (replaced by the decoder). In aspects described herein, a CSI encoder at the user equipment side may be trained to compress the channel estimate to a few bits that are then reported to a network entity (e.g., a base station), while the CSI decoder at the network entity side is trained to recover the channel or the precoding matrix using the reported bits.

Thus, generally speaking, machine learning models may be trained to perform many functions related to channel estimation and feedback, and such models may generally be more accurate, faster, more power efficient, and more capable of maintaining performance in very dynamic radio environments. However, it is nevertheless important to monitor the performance of such machine learning models to ensure robust performance over time.

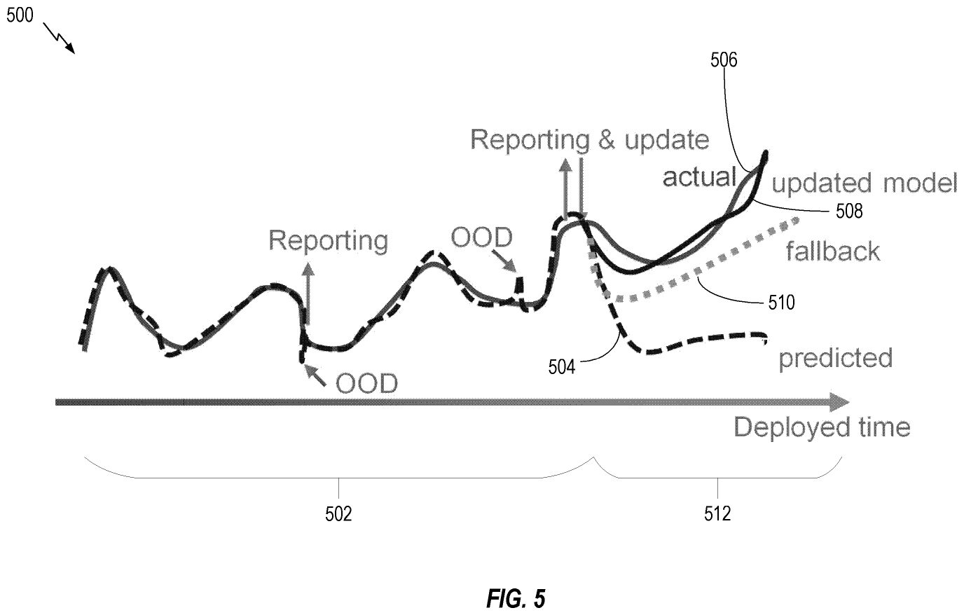

FIG. 5 depicts an example 500 of monitoring a machine learning model performance over time.

As depicted, during time interval 502, the model output 504 closely tracks the actual values 506 (e.g., of a channel estimation). The model may be deployed by a user equipment, such as user equipment 104 described with respect to FIGS. 1 and 3. During interval 502, there are two reporting events in which the device deploying the model reports the performance of the model, including the two out-of-distribution (OOD) events. Notably, the OOD events depict instances in which model output deviates significantly (e.g., based on a threshold) from the actual values 506. In these instances, the trained model may be processing input data that is significantly different than the training data used to train the model, and thus the model output becomes unreliable. Based on these OOD events, a network entity, such as the base station 102 described with respect to FIGS. 1-3, may determine to send a model update.

The second time interval 504 demonstrates various possible outcomes. Without a model update, the original model output 504 deviates significantly from the actual values 506. By contrast, the updated model output 508 again closely tracks the actual values 506. Further, a fallback method, such as a conventional, non-machine learning-based method, is depicted to demonstrate that such methods may be better than a poorly performing machine learning model, but worse than a well performing machine learning model.

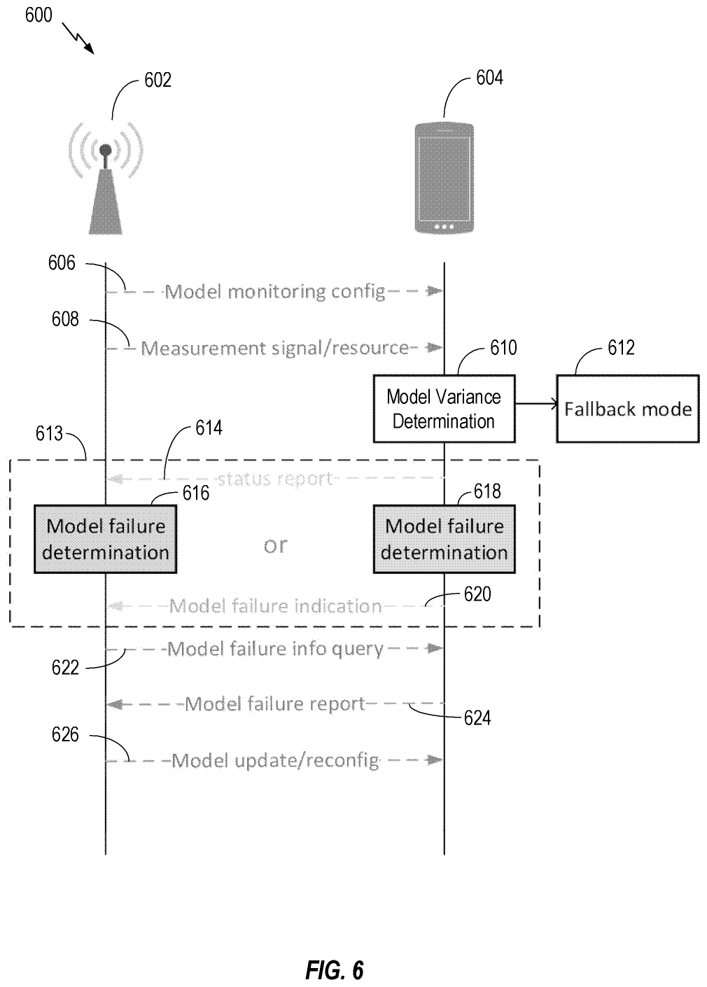

FIG. 6 depicts an example of a model monitoring framework 600.

In framework 600, a network entity 602 (e.g., the base station 102 depicted and described with respect to FIGS. 1 and 3 or the disaggregated base station depicted and described with respect to FIG. 2.) is in communications with a user equipment (e.g., the user equipment 104 depicted and described with respect to FIGS. 1 and 3.).

At step 606, network entity 602 sends a model monitoring configuration to user equipment 604. The model monitoring configuration may define, for example, a number of modes for the user equipment to employ as well as, in some cases, an indication of which mode to employ.

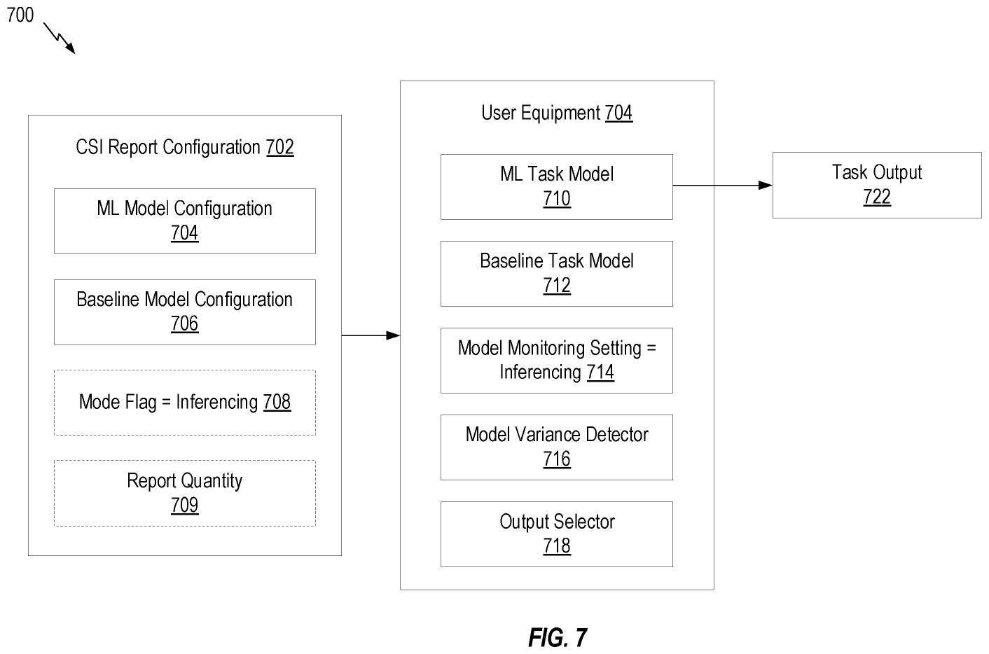

In some aspects, the model monitoring configuration may include an inferencing mode (or task mode) in which user equipment 604 employs a machine learning model to perform a task and relies on the output of the model for that task. For example, user equipment 604 may use a machine learning model for channel estimation and/or channel state information (CSI) feedback. In particular, user equipment 604 may generate channel estimates based on a reduced set of CSI reference signals (CSI-RSs) using a machine learning model. Further, user equipment 604 may generate CSI feedback using a machine learning model trained to generate such feedback based on channel estimates (using the aforementioned machine learning model, or other methods). FIG. 7 depicts one example of a model monitoring configuration for an inferencing mode.

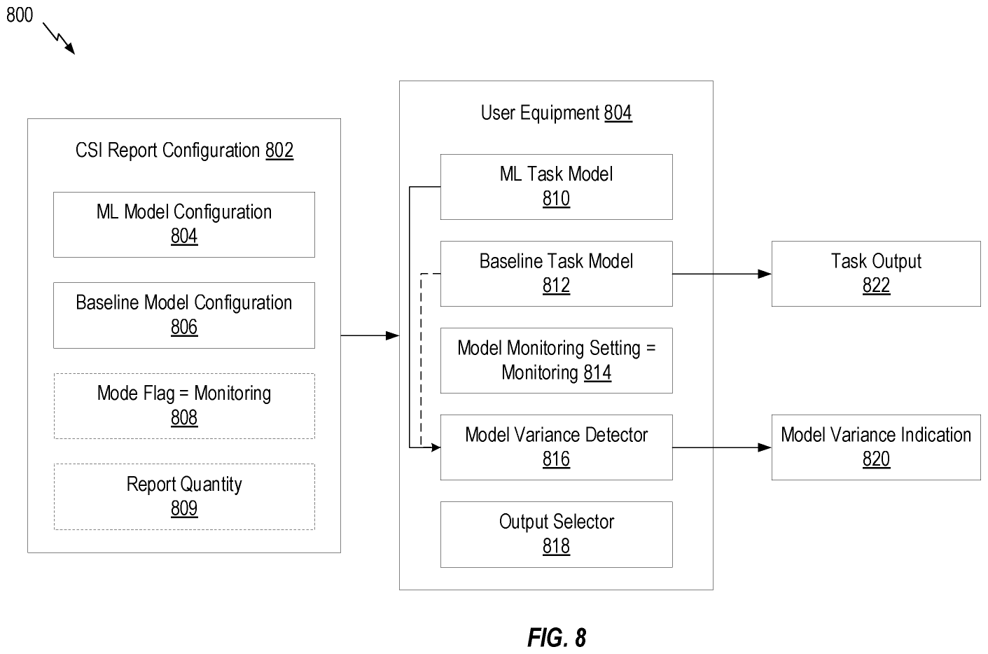

In some aspects, the model monitoring configuration may include a monitoring mode in which user equipment 604 monitors the output of a machine learning model for model variance events, such as OOD events (e.g., as described above and with respect to FIG. 5). For example, user equipment 604 may monitor channel estimates and/or CSI feedback generated by machine learning models for model variance event. The monitoring mode may be useful when first deploying a machine learning model to determine its performance, such as for validating a model after training or updating. Further, the monitoring mode may be useful when comparing the machine learning model performance to a baseline model (e.g., a conventional technique for performing a task) in order to determine which model (machine learning or baseline) to enable for the task. FIG. 8 depicts one example of a model monitoring configuration for a monitoring mode.

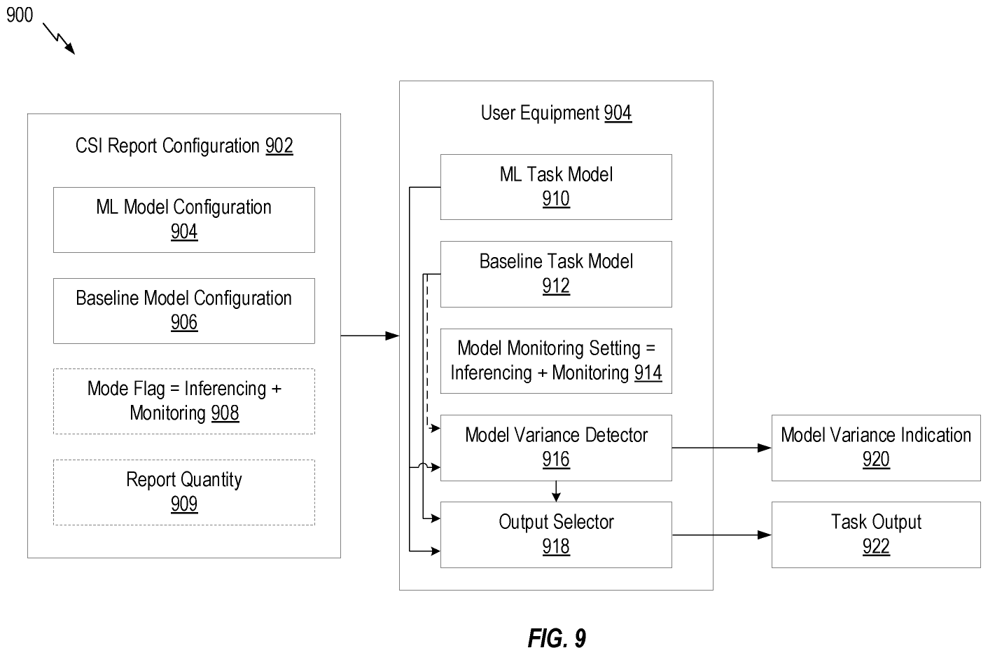

In some aspects, the model monitoring configuration may include an inferencing and monitoring mode in which user equipment 604 both performs inferencing and monitoring as described above. In particular, when performing inferencing and monitoring, it is possible for user equipment to determine whether a given model output (e.g., inference) is variant (e.g., an OOD event), and then select the task output (e.g., for channel estimation and/or CSI feedback) based on the model variance determination. For example, if there machine learning model output is variant, then user equipment 604 may use a fallback method (e.g., a baseline model) for task output, and if the machine learning model is not variant, then the user equipment 604 may use the machine learning model output for task output. Thus, in the inferencing and monitoring mode, user equipment 604 may “trust, but verify” a machine learning model, and choose to fallback to a baseline model if performance degrades over time, such as in time interval 512 of FIG. 5. FIG. 9 depicts one example of a model monitoring configuration for an inferencing and monitoring mode.

At step 608, network entity 602 sends a reference signal (e.g., a measurement signal or resource) to user equipment 604. For example, the reference signal may be a CSI-RS for user equipment 604 to perform channel estimation and to generate CSI feedback.

At step 610, user equipment 604 performs a model variance determination (e.g., an OOD event determination). For example, user equipment 604 may be operating in a monitoring or an inferencing and monitoring mode, as described above.

Generally, determining a model variance may be performed in a variety of ways. For example, for determining a model variance with respect to a machine learning-based CSF model, the statistics of latent output of a CSI encoder, or for inner layers of the CSI encoder, may be used to determine a model variance. As another example, a further model may be trained to take the output of a CSI encoder and classify it as variant or not. Note that herein, the output from a machine learning-based CSI encoder may be referred to as Type III CSI.

As another example, determining model variance for a machine learning-based CSF model may be based on comparing the output of a CSI encoder to a baseline model, such as a baseline codebook (e.g., Type I/II or (F) eType II CSI). In such an example, a baseline codebook would be configured as well as the machine learning-based CSI encoder. In some aspects, the difference between the CSI encoder and the baseline model may be compared to a threshold, above which the model output is considered variant, and below which the model output is considered normal.

As another example, determining model variance for a machine learning-based CSF model may be based on an error metric (e.g., normalized mean squared error (NMSE)) associated with the machine learning-based CSF model. In some cases, the model-based error metric may be compared to a channel estimation error metric and if the difference is above a threshold, the CSF model output may be considered variant, and if the difference is below the threshold, the CSF model output may be considered normal.

As a further example, determining model variance for a machine learning-based CSF model may be based on PDSCH decoding performance, such that if the PDSCH block error rate (BLER) is below a threshold (e.g., <<10%) or above a threshold (e.g., >>10%), the model output may be considered variant.

Similarly, determining a model variance with respect to a machine learning-based CSI-RS model may be performed in many different ways. For example, statistics of latent output of a CSI-RS model, or for inner layers of the CSI-RS model, may be used to determine a model variance. As another example, a further model may be trained to take the output of a CSI-RS model and to classify it as variant or not.

As another example, determining a model variance with respect to a machine learning-based CSI-RS model may be based on comparing NMSE of the CSI-RS model optimized CSI-RS to a baseline model and a threshold, such that if NMSE is above that of the baseline model and below a threshold, the CSI-RS model output is considered variant.

As another example, determining a model variance with respect to a machine learning-based CSI-RS model may be based on channel quality metrics. In one aspect, if the CQI/spectral-efficiency results of CSI-RS model optimized CSI-RS is worse than a baseline model and below a threshold, then the CSI-RS model output is considered variant. As above, a baseline model could include a baseline codebook (e.g., Type I/II or (F) eType II CSI).

Based on the model variance determination, user equipment 604 optionally proceeds to a fallback mode at step 612. For example, in the fallback mode, user equipment 604 may implement a baseline model for a task that it was previously performing with a machine learning model, such as using a PMI searching algorithm rather than a machine learning model for generating CSI feedback.

Box 613 depicts different methods for making a model failure determination.

In a first example, at step 614, user equipment 604 sends a status report to network entity 602 including the model variance determination. Note that the status report may include multiple model variance determinations (e.g., a count of model variance determinations over a monitoring interval). Based on status report 614, network entity 602 performs a model failure determination at step 616. For example, the model failure determination may be based on a number of model variance events over a monitoring interval.

In a second example, at step 618, user equipment 604 performs a model failure determination. For example, the model failure determination may be based on a number of model variance events over a monitoring interval, as described above. Then at step 620, user equipment 604 sends a model failure indication to network entity 602.

At step 622, network entity 602 sends a model failure info query to user equipment 604, and user equipment 604 responds with a model failure report at step 624. In some aspects, the model failure report may include, for example, information about the model that has failed (e.g., a version, a time the model has been deployed, etc.) as well as input and/or output values associated with one or more model variance events that led to the model failure determination. Such values may be used for updating the machine learning model.

Finally, at step 626, network entity 602 sends a model update (e.g., for reconfiguring the machine learning model that had failed) to user equipment 604. With the model update, user equipment 604 may update the model and improve task performance (e.g., as shown with respect to line 508 in FIG. 5).

Note that FIG. 6 is just one example of a method, and other methods including fewer, additional, or alternative steps are possible consistent with this disclosure.

FIG. 7 depicts an example 700 of a model monitoring configuration 702 for an inferencing mode.

In particular, CSI report configuration 702 includes a machine learning model configuration 704 that may be used by user equipment 704 for configuring a machine learning model for some task, such as channel estimation or CSI feedback (e.g., by way of a CSI report). For example, machine learning model configuration 704 may configure a machine learning model for Type III CSI.

CSI report configuration 702 further includes a baseline model configuration 706 for configuring a conventional model or technique for some task, such as channel estimation or CSI feedback. For example, baseline model configuration 704 may configure a baseline model for Type I, II, or (F) e Type II CSI.

CSI report configuration 702 further includes an optional mode flag 708, which in this example is set to indicate an inferencing mode. Note that in other aspects, CSI report configuration 702 may be specific to an inferencing mode, rather than having a flag (or other indicator) that can indicate one of many model monitoring modes. In such cases, mode flag 708 could be omitted and report quantity 709 may be used to configure user equipment, such as described further below with respect to FIG. 8.

CSI report configuration 702 is provide to user equipment 704 (e.g., by a network entity) and configures user equipment 704 for a particular channel estimation and/or feedback related task in this example.

In this example, user equipment 704 includes a machine learning task model 710 (e.g., a channel estimation or CSI feedback model), a baseline task model 712, a model monitoring setting 714, which in this example is set for inferencing mode, a model variance detector 716, and an output selector 718.

Because in this example user equipment 704 is configured by CSI report configuration 702 in an inferencing mode, machine learning task model 710 is used to generate task output 722, which may be, for example, a channel estimate, CSI feedback, or other types of output.

FIG. 8 depicts an example 800 of a model monitoring configuration 802 for a monitoring mode.

In particular, CSI report configuration 802 includes a machine learning model configuration 804, baseline model configuration 806, and an optional mode flag 808, which in this example is set to indicate a monitoring mode.

CSI report configuration 802 is provided to user equipment 804 (e.g., by a network entity) and configures user equipment 804 for a particular channel estimation and/or feedback related task in this example.

As in the example of FIG. 7, here user equipment 804 includes a machine learning task model 810, a baseline task model 812, a model monitoring setting 814, which in this example is set for monitoring mode, a model variance detector 816, and an output selector 818.

Because in this example user equipment 804 is configured by CSI report configuration 802 in a monitoring mode, baseline task model 812 is used to generate task output 822, which may be, for example, a channel estimate, CSI feedback, or other types of output.

Additionally, machine learning task model 810 generates output that is monitored for model variance events (e.g., OOD events), which, when detected, can be used to send model variance indications (e.g., in a status report, such as 614 in FIG. 6) and/or can be used for determining a model failure.

As described above with respect to FIG. 6 step 610, there are many ways that model variance detector 816 can detect model variance events (e.g., OOD events). In one example, the output of machine learning task model 810 and baseline task model 812 may be compared, and if the output of machine learning task model 810 is worse than baseline task model 812 (e.g., subject to a threshold), then the output of machine learning task model 810 may be considered variant and reported in model variance indication 820.

As above, there are other methods that do not require using the output of baseline task model 812 to determine a model variance event (thus the broken arrow between baseline task model 812 and model variance detector 816). For example, latent statistics and/or error metrics associated with machine learning task model 810 may be considered, or a separate classification model (e.g., a neural network model) may be used to classify the output as variant or not, as discussed above with respect to FIG. 6 step 610.

Note that in other aspects, CSI report configuration 802 may be specific to a particular monitoring mode (e.g., there is a dedicated CSI report for monitoring, for inferencing, etc.), and in such cases, CSI report configuration 802 need not include a flag (or other indicator) to indicate one of many model monitoring modes. Rather, in such cases, CSI report configuration 802 may include a report quantity 809 (e.g., “reportQuantity” in the 3GPP standard) that causes user equipment 804 to report model variance events or to initiate model failure indications. For example, one value of the report quantity 809 in CSI report configuration 802 may cause user equipment 804 to perform step 614 in FIG. 6 and report model variance events, whereas another report quantity 809 in CSI report configuration 802 may cause user equipment 804 to perform steps 618 and 620 in FIG. 6 and report model failure events. Accordingly, CSI report configuration 802 may configure a user equipment through use of the report quantity to report model variance events or model failures periodically, semi-persistently, or aperiodically as triggered.

FIG. 9 depicts an example 900 of a model monitoring configuration 902 for an inferencing and monitoring mode.

In particular, CSI report configuration 902 includes a machine learning model configuration 904, baseline model configuration 906, and an optional mode flag 908, which in this example is set to indicate an inferencing and monitoring mode.

CSI report configuration 902 is provided to user equipment 904 (e.g., by a network entity) and configures user equipment 904 for a particular channel estimation and/or feedback related task in this example.

As in the example of FIGS. 7 and 8, here user equipment 904 includes a machine learning task model 910, a baseline task model 912, a model monitoring setting 914, which in this example is set for inferencing and monitoring mode, a model variance detector 916, and an output selector 918.

Because in this example user equipment 904 is configured by CSI report configuration 902 in the inferencing and monitoring mode, machine learning task model 910 and baseline task model 812 are both used to generate preliminary task outputs.

Machine learning task model 910's preliminary task output is provided to model variance detector 916, which determines if the preliminary task output is variant (e.g., an OOD output). As described above with respect to FIG. 6 step 610, there are many ways that model variance detector 916 can detect model variance events (e.g., OOD events).

In one example, the output of machine learning task model 910 and baseline task model 912 may be compared, and if the output of machine learning task model 910 is worse than baseline task model 912 (e.g., subject to a threshold), then the output of machine learning task model 910 may be considered variant and reported in model variance indication 820.

Additionally, there are other methods that do not require using the output of baseline task model 912 to determine a model variance event (thus the broken arrow between baseline task model 912 and model variance detector 916). For example, latent statistics and/or error metrics associated with machine learning task model 910 may be considered, or a separate classification model (e.g., a neural network model) may be used to classify the output as variant or not, as discussed above with respect to FIG. 6 step 610.

If the output of machine learning task model 910 is variant, then output selector 918 selects the baseline task model 912 preliminary output as overall task output 922, which may be, for example, a channel estimate, CSI feedback, or other types of output. Further, model variance detector 916 may generate and send a model variance indication 920 and/or can be used for determining a model failure.

If, on the other hand, model variance detector 916 determines that the preliminary task output of machine learning task model 910 is not variant, then output selector 918 selects machine learning task model 910 preliminary output as overall task output 922.

As above with FIG. 8, in some aspects, rather than including mode flag 908, CSI report configuration 902 may be specific to a particular monitoring mode (e.g., there may be a dedicated CSI report for monitoring and inferencing mode). In such cases, CSI report configuration 802 may include a report quantity 909 that causes user equipment 904 to report model variance events (e.g., via model variance indication 920) or to initiate model failure indications. For example, one value of the report quantity 909 in CSI report configuration 902 may cause user equipment 904 to perform step 614 in FIG. 6 and report model variance events, whereas another report quantity 909 in CSI report configuration 802 may cause user equipment 804 to perform steps 618 and 620 in FIG. 6 and report model failure events.

FIGS. 7-9 depict certain examples of using CSI report configurations for confirming model monitoring settings on a user equipment. Note, however, that these are just some examples and a user equipment may be configured in other ways as well.

For example, for any CSI report configured on a user equipment, a mode flag can be included in alternative signaling, including radio resource control (RRC) signaling, medium access control control element (MAC-CE), downlink control information (DCI), and others.

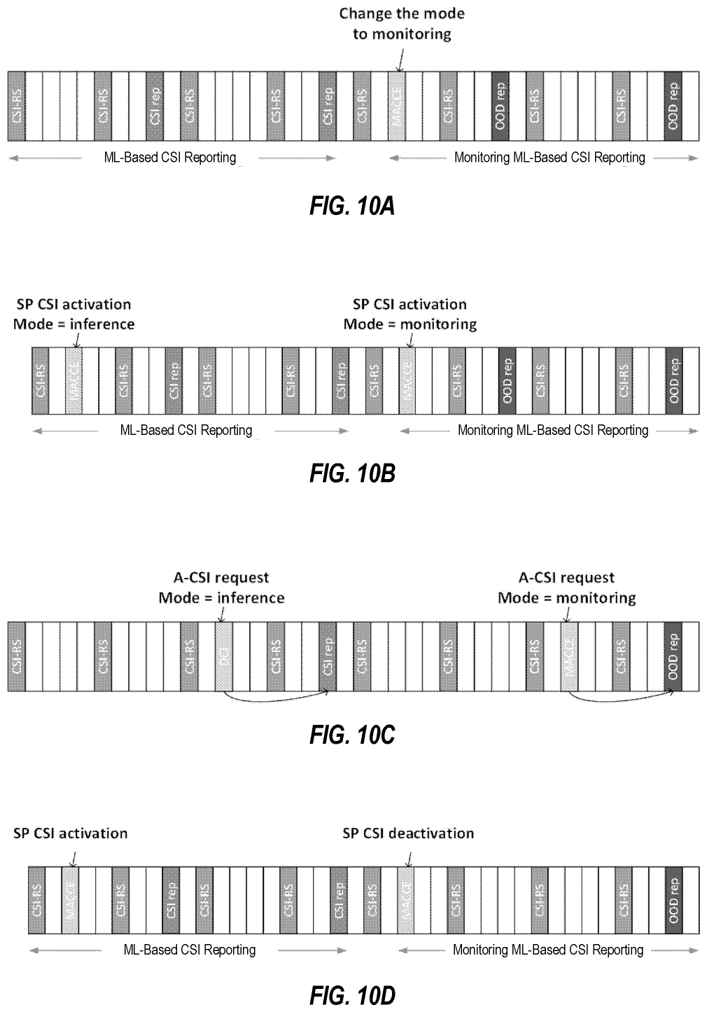

In one aspect, for periodic CSI, a mode flag may be included in a CSI reporting configuration, as in the examples of FIGS. 7-9, for an initial configuration, and a mode change may be affected via RRC reconfiguration, and/or a MAC-CE command, as depicted in the example of FIG. 10A.

In another aspect, for semi-persistent CSI (e.g., on physical uplink control channel (PUCCH)), a mode flag may be provided together with an activation MAC-CE, or the activation may be provided via a separate MAC-CE, as depicted in the example of FIG. 10B. In such aspects, a list of semi-persistent (SP) CSI may be included in the MAC-CE, and each is provided with a particular mode flag, or a common flag set to all of these triggered SP CSI reports.

For semi-persistent and aperiodic CSI on PUSCH, a mode flag may be indicated with CSI request DCI, as depicted in the example of FIG. 10C. In such aspects, a list of semi-persistent/aperiodic CSI are provided, each with a particular mode flag, or a common flag set to all of these triggered SP/A CSI reports.

Alternative, a mode change may be implicitly determined according to, for example, a pre-defined rule. For example, for semi-persistent/aperiodic CSI, once the CSI is triggered, the mode is set to inferencing; otherwise, the mode is set to monitoring, as depicted in the example of FIG. 10D.

### Model Variance Event Counting

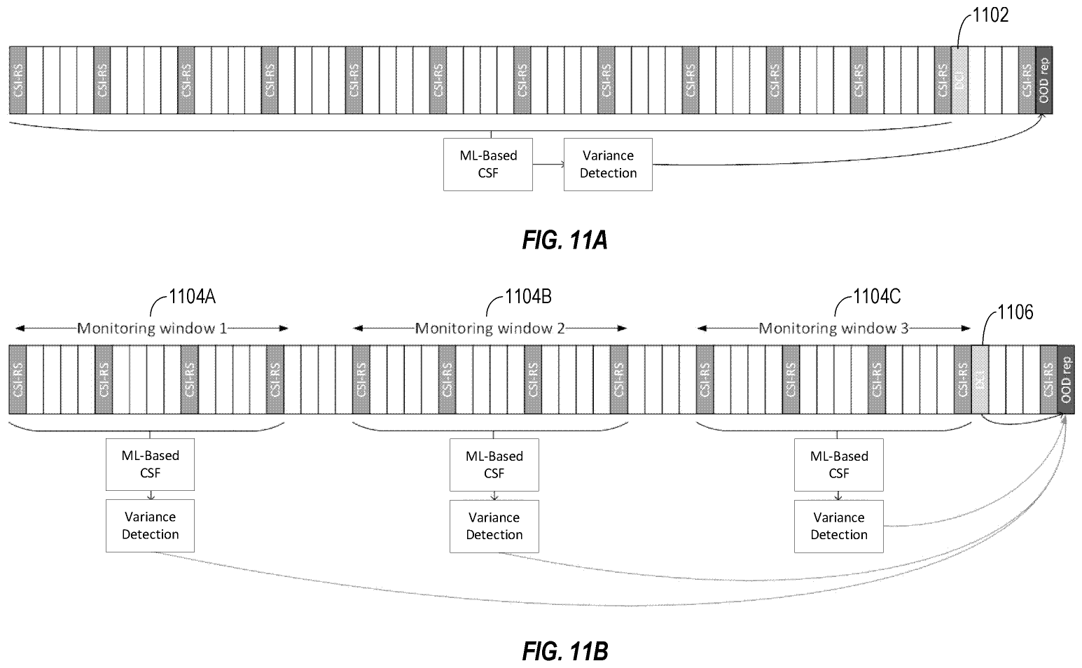

FIGS. 11A-11B depict example methods for counting model variance events (e.g., OOD events).

In particular, FIG. 11A depicts an example of performing one model variance event detection per model variance event reporting. In this example, the counting of model variance events (e.g., OOD events) is not based on (or restricted by) any number of CSI-RS occasions in time domain. Rather, the user equipment evaluates the model variance event using all the CSI-RS occasions prior to a CSI reference resource, and reports the evaluation result per report occasion. In other words, the user equipment is configured to use specific CSI-RS occasions to perform the model variance event detection. The user equipment can freely use all of the CSI-RS observations, or the most recent one to this end.

FIG. 11B depicts another alternative, in which counting of model variance events is based on a number of CSI-RS occasions in the time domain. For example, in some aspects, a monitoring occasion (or interval or window) comprises a configured number (e.g., N) CSI-RS occasions in the time domain. Further, in some aspects, one model variance event determination is made per monitoring occasion (e.g., as depicted by example monitoring windows 1104A-C). Accordingly, in the example of FIG. 11B, there is a defined association between specific CSI-RS occasions and a specific model variance determination.

In this example, the monitoring occasions 1104A-C are non-overlapping, but in other examples, one or more monitoring occasions may be overlapping. Further in this example, the monitoring occasions 1104A-C are counted using the CSI-RS occasions before the CSI reference resource, which in this example is DCI trigger 1106 for aperiodic-CSI reporting of model variance events.

### Model Variance Event and Model Failure Reporting

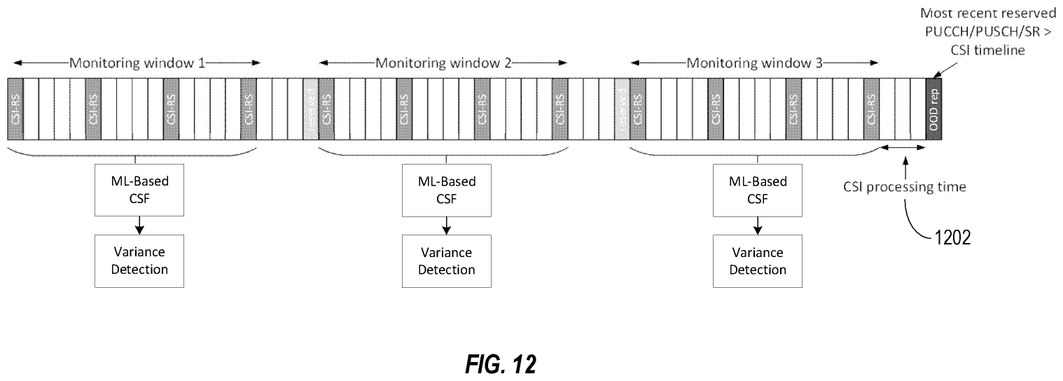

FIG. 12 depicts aspects related to reporting model variance events and model failures, such as when a user equipment is operating in a monitoring mode.

In some aspects, a device (e.g., a user equipment) may report model variance events (e.g., OOD events) via PUCCH/PUSCH messaging as configured and/or triggered by a network. In one example, a user equipment may report one model variance event per report, which generally works with model variance event counting methods discussed above with respect to both FIG. 11A and FIG. 11B. In the case of the method of FIG. 11B, then a user equipment may be configured to report whether a model is variant (or not) in the latest measurement window. In another example, a user equipment may report a number (count) of model variance events out of a number (e.g., M) of monitoring occasions. The number, M, may be configured by a network.

Further, a device (e.g., user equipment) may initiate a model failure indication (e.g., as in step 620 of FIG. 6) if a number of model variance events during a monitoring window (e.g., during M monitoring occasions) exceed a threshold.

In some cases, after reporting a model failure, a user equipment may then refrain from reporting a second model failure report until a timer expires to allow time for a network to respond (e.g., by sending a model update as in step 626 of FIG. 6). In some aspects, a model failure indication may be sent via a reserved uplink resource (e.g., in a PUCCH, PUSCH, or sounding reference (SR) resource). In such cases, the PUCCH, PUSCH, or SR resource periodicity and slot offset may be configured via RRC (e.g., with a one-to-one mapping with a CSI report configuration). Thus, the exact time slot may be determined as the most recent PUCCH, PUSCH, or SR occasion that satisfies the CSI processing timeline 1202, which means that the actual slot of PUCCH/PUSCH/SR is the most recent PUCCH/PUSCH/SR that is at least N slots/symbols after the latest CSI-RS occasion, where N is the CSI processing timeline for model variance or model failure event detection.

### Model Management for CSI-RS Optimization

As discussed above, machine learning models may be also used for CSI-RS optimization to reduce CSI-RS overhead, and, as above, it is beneficial to monitor such a model to ensure its continued performance, and to select alternatives methods if the model begins to vary from actual data, such as described above with respect to FIG. 5.

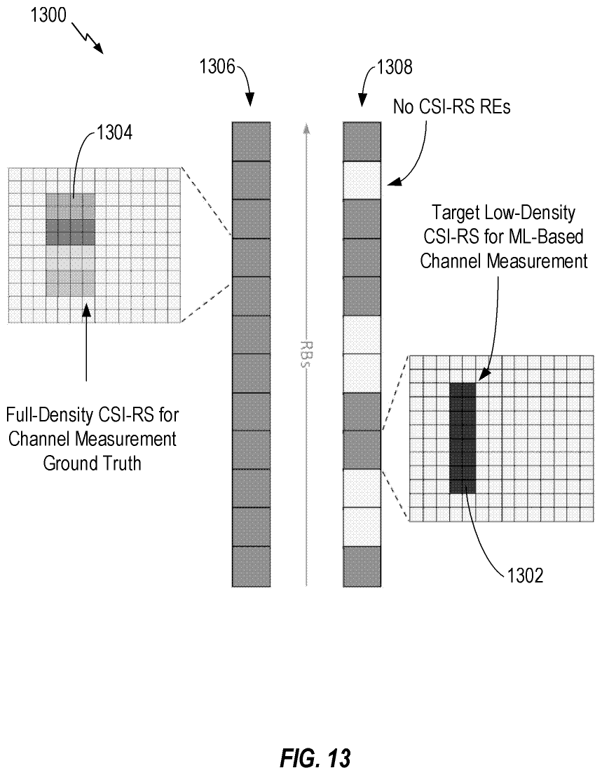

FIG. 13 depicts an example 1300 of using low-density CSI-RS for machine learning model-based channel estimation.

Generally, in FIG. 13, resource blocks 1306 include full density CSI-RS (e.g., 1304), which are indicated as darker blocks, while resource blocks 1308 include low-density CSI-RS (e.g., 1302) pattern. Resource blocks 1306 may represent a conventional CSI-RS transmission in which every resource block has CSI-RS, and inside each resource block, there are 32 ports orthogonally multiplexed on 32 resource elements. By contrast, in resource blocks 1308, the resource block-level density is reduced, and multiplexing inside each resource block is determined by a machine learning model. For example, a machine learning model may multiplex 32 ports on fewer resource elements, such as 16 (as depicted) or 8 resource elements.

Low-density CSI-RS (e.g., 1302) may be measured (e.g., by a user equipment) and provided as input to a machine learning-based channel estimation model, which uses the measurements to estimate the channel and to generate CSI feedback.

In order to monitor a machine learning-based channel estimation model, a full set of CSI-RS resource elements 1304 (e.g., a full-density set) may be measured (e.g., by a user equipment) and used as a ground-truth to assess the performance of the machine-learning-based models deployed my a network entity to generate the low-density CSI-RS transmission and a machine learning model deployed by a user equipment to perform channel estimation based on the low-density CSI-RS transmission. For example, CSI-RS resource elements 1302 may be measured by a user equipment configured in an inferencing mode, and CSI-RS resource elements 1302 and 1304 may be measured by the user equipment configured in a monitoring mode or an inferencing and monitoring mode.

Generally, management of model monitoring modes for a machine learning-based channel estimation model may be performed as described above with respect to FIGS. 6-12.

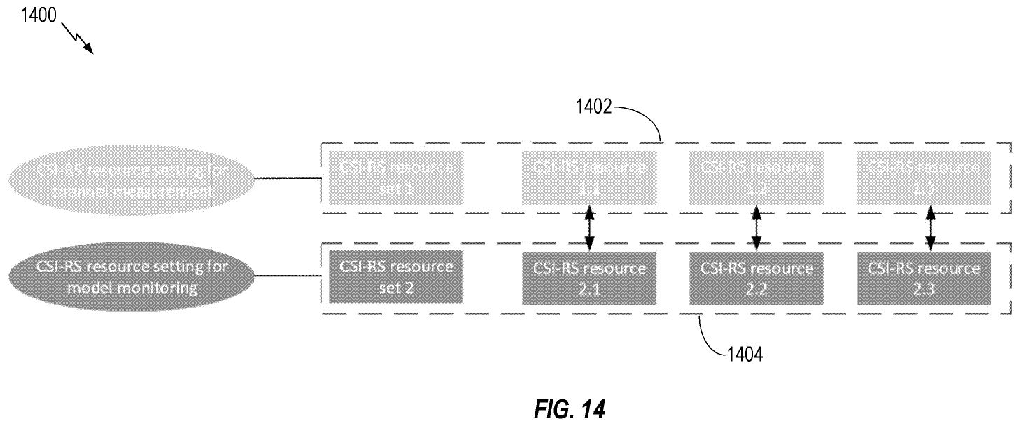

For example, a monitoring mode may be enabled via a mode flag in a CSI report configuration (as discussed with respect to FIGS. 7-9). In such an example, a paired CSI-RS resource may be configured in the CSI report configuration, including a first resource set that is a target optimized resource set (e.g., 1302) and a second resource set that is full-port and full bandwidth as a reference resource set (e.g., 1304). Thus, if the monitoring mode is inferencing, the first resource set (the target optimized set) is measured and used for channel estimation and generating CSI feedback, whereas if the monitoring mode is monitoring, both the first and second sets of resources are measured, and the second set serves as a ground-truth. As depicted and described below with respect to FIG. 14, there may be a one-to-one mapping between resources in the first (target) resource set and the second (reference, or ground-truth) resource set.

As another example, a monitoring mode may be enabled via a dedicated CSI report configuration for a CSI-RS machine learning model. As described above with respect to FIGS. 8 and 9, a report quantity in the CSI report configuration may be used to indicate to a user equipment whether, for example, it should report model variance events (e.g., OOD events) or whether it should initiate model failure indications. Accordingly, a dedicated CSI report configuration may configure a user equipment through use of the report quantity to report model variance events or model failures periodically, semi-persistently, or aperiodically as triggered.

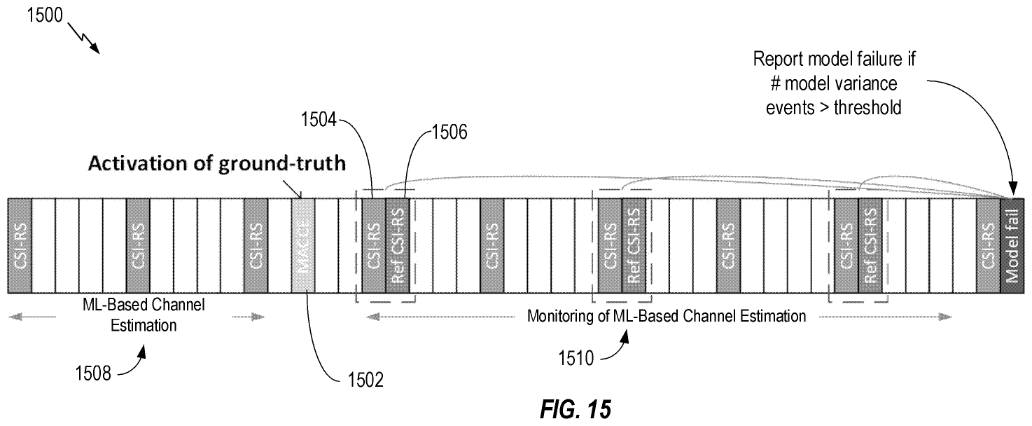

As yet another alternative, a monitoring mode may be enabled via a CSI-RS resource setting configuration or activation. In such an example, a second resource set is configured (if the second set is periodic) or activated (if the second set is semi-persistent) or triggered (if the second set is aperiodic) as a ground-truth set for the first resource set, which may already be configured or activated. In some aspects, a target resource in the first resource set may be associated with a reference resource in the second resource set via an RRC configuration of either the target resource or the reference resource, or included in a MAC-CE activation of the target resource or the reference resource, such as described in more detail below with respect to FIG. 15.

FIG. 14 depicts an example 1400 of paired CSI-RS resources between a first (target) resource set 1402 and a second (reference) resource set 1404.

Detecting model variance events for a machine learning-based channel estimation model may be similar as described above with respect to step 610 of FIG. 6. For example, one option is to determine a model variance based on a statistic of the latent output of a layer the machine learning-based channel estimation model. Another options is to use a separate module (e.g., a separate model) to determine the model variance event based on the output of the machine learning-based channel estimation model. Yet another option is to determine an error metric (e.g., normalized mean squared error) for the machine learning-based channel estimation model (e.g., based on ground truth measurements) and compare it to a threshold. Another option is to determine the channel quality indicator (CQI) and/or spectral-efficiency using the machine learning-based channel estimation model and compare it to a baseline model (e.g., a baseline codebook, e.g., Type I/II, (F) eType II) and see if the difference exceeds a threshold. Note that there are just a few examples, and others are possible.

Reporting model variance events and model failure (e.g., as in steps 614 and 620 of FIG. 6) for a machine learning-based channel estimation model may generally be as described above with respect to FIGS. 11A and 11B.

For example, FIG. 15 depicts an example 1500 of triggering a model monitoring mode for a machine learning-based channel estimation model.

In FIG. 15, a MAC-CE 1502 activates a monitoring mode for interval 1510 (changing from an inference mode during interval 1508) in which a user equipment monitors both a target (e.g., low-density) CSI-RS resource set and a reference (e.g., full-density) CSI-RS resource set. Based on the monitoring, a model failure determination (e.g., as in step 618 of FIG. 6) is made and if the model has failed, it is reported at 1504 (e.g., as in step 620 of FIG. 6).

As depicted in FIG. 15, a target CSI-RS resources (e.g., 1504) may be associated with a reference CSI-RS resources (e.g., 1506). As above, once the reference CSI-RS resource is activated by an activation command (e.g., MAC-CE 1502), a user equipment may start the monitoring based on the target and reference resources. Note that an association between a target CSI-RS resource (e.g., 1504) and a reference CSI-RS resource (e.g., 1506) can be made via dedicated signaling, such as RRC signaling. Alternatively, a MAC-CE (e.g., 1502) may indicate to a user equipment which is the target CSI-RS resource and which is the reference CSI-RS resource.

### Example Operations of a User Equipment

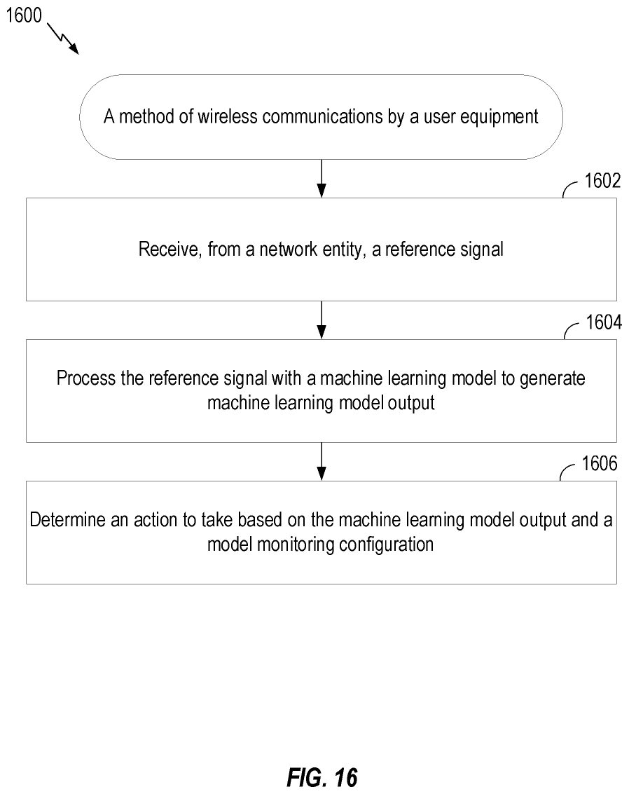

FIG. 16 shows an example of a method 1600 for wireless communications by a user equipment, such as UE 104 of FIGS. 1 and 3.

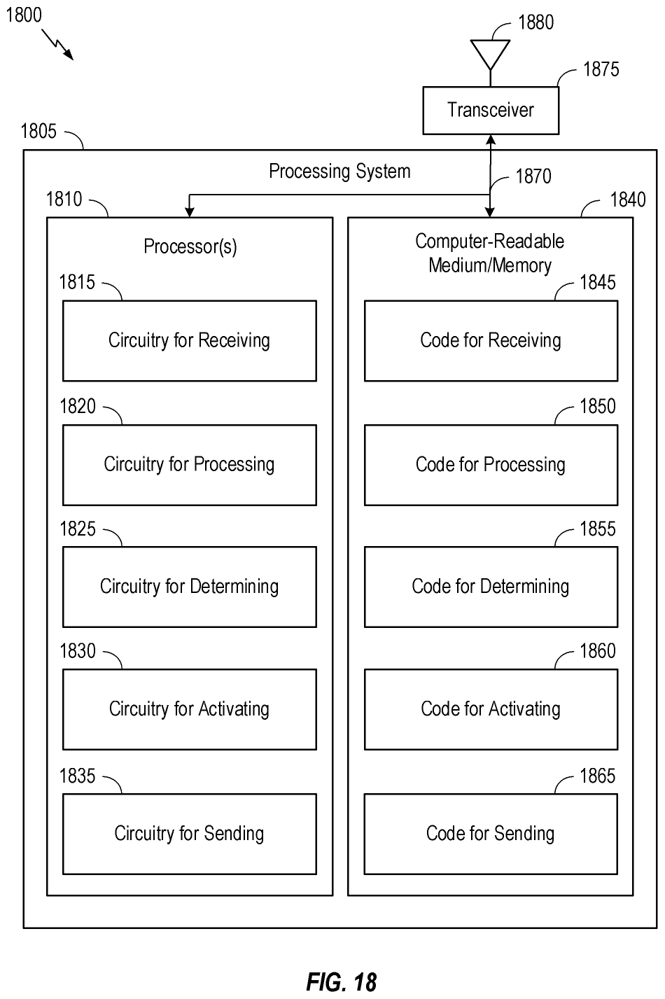

Method 1600 begins at step 1605 with receiving, from a network entity, a reference signal. In some cases, the operations of this step refer to, or may be performed by, circuitry for receiving and/or code for receiving as described with reference to FIG. 18.

Method 1600 then proceeds to step 1610 with processing the reference signal with a machine learning model to generate machine learning model output. In some cases, the operations of this step refer to, or may be performed by, circuitry for processing and/or code for processing as described with reference to FIG. 18.

Method 1600 then proceeds to step 1615 with determining an action to take based on the machine learning model output and a model monitoring configuration. In some cases, the operations of this step refer to, or may be performed by, circuitry for determining and/or code for determining as described with reference to FIG. 18.

In some aspects, the method 1600 further includes receiving the model monitoring configuration from the network entity. In some cases, the operations of this step refer to, or may be performed by, circuitry for receiving and/or code for receiving as described with reference to FIG. 18.

In some aspects, the model monitoring configuration defines a plurality of model monitoring states.

In some aspects, the method 1600 further includes receiving, from the network entity, a channel state information reporting configuration configured to cause the user equipment to enable a selected model monitoring state of the plurality of model monitoring states. In some cases, the operations of this step refer to, or may be performed by, circuitry for receiving and/or code for receiving as described with reference to FIG. 18.

In some aspects, each respective model monitoring state of the plurality of model monitoring states is associated with a respective mode flag, and the channel state information reporting configuration comprises a mode flag configured to cause the user equipment to enable the selected model monitoring state of the plurality of model monitoring states.

In some aspects, the method 1600 further includes receiving, from the network entity via RRC messaging, a mode flag configured to cause the user equipment to enable another model monitoring state of the plurality of model monitoring states. In some cases, the operations of this step refer to, or may be performed by, circuitry for receiving and/or code for receiving as described with reference to FIG. 18.

In some aspects, the method 1600 further includes receiving, from the network entity via one or more MAC-CEs, a mode flag configured to cause the user equipment to enable another model monitoring state of the plurality of model monitoring states. In some cases, the operations of this step refer to, or may be performed by, circuitry for receiving and/or code for receiving as described with reference to FIG. 18.

In some aspects, the method 1600 further includes receiving, from the network entity via DCI, a mode flag configured to cause the user equipment to enable another model monitoring state of the plurality of model monitoring states. In some cases, the operations of this step refer to, or may be performed by, circuitry for receiving and/or code for receiving as described with reference to FIG. 18.

In some aspects, the channel state information reporting configuration configures a first set of target CSI-RS resources and a second set of reference CSI-RS resources, each target CSI-RS resource in the first set of target CSI-RS resources is paired with a reference CSI-RS resource in the second set of reference CSI-RS resources, and the channel state information reporting configuration is configured to further cause the user equipment to determine whether to measure the second set of reference CSI-RS resources based on the selected model monitoring state.

In some aspects, the channel state information reporting configuration comprises a mode flag configured to cause the user equipment to determine whether to measure the second set of reference CSI-RS resources based on the selected model monitoring state.

In some aspects, the method 1600 further includes receiving, from the network entity, a resource indication configured to cause the user equipment to determine whether to measure the second set of reference CSI-RS resources based on the selected model monitoring state. In some cases, the operations of this step refer to, or may be performed by, circuitry for receiving and/or code for receiving as described with reference to FIG. 18.

In some aspects, the method 1600 further includes activating a model monitoring state of the plurality of model monitoring states based on a predefined rule. In some cases, the operations of this step refer to, or may be performed by, circuitry for activating and/or code for activating as described with reference to FIG. 18.

In some aspects, the action comprises sending the machine learning model output to the network entity.

In some aspects, the action comprises determining a model variance event based on the machine learning model output.

In some aspects, determining the model variance event comprises at least one of: determining statistics associated with the machine learning model output; processing the machine learning model output with a variance model configured to determine the model variance event; determining that an error metric associated with the machine learning model output is above a threshold; determining that the machine learning model output differs from a baseline model output by more than a threshold; or determining that an error metric associated with decoding performance at the user equipment is above a threshold.

In some aspects, the action further comprises sending, to the network entity, an indication of the model variance event.

In some aspects, the method 1600 further includes receiving, from the network entity, an indication of a model failure event associated with the machine learning model. In some cases, the operations of this step refer to, or may be performed by, circuitry for receiving and/or code for receiving as described with reference to FIG. 18.

In some aspects, the indication of the model variance event is included in a report associated with a single model variance event.

In some aspects, the indication of the model variance event is included in a report associated with a plurality of model variance events occurring within a predetermined number of model variance event monitoring occasions.

In some aspects, the action further comprises: determining a model failure event based on the model variance event; and sending, to the network entity, an indication of the model failure event associated with the machine learning model.

In some aspects, determining the model failure event comprises: incrementing a model variance event counter value; and determining that the model variance event counter value exceeds a model variance event count threshold during a monitoring interval.

In some aspects, the monitoring interval comprises a model variance event reporting interval.

In some aspects, the monitoring interval comprises a predetermined number of channel state information reference signal occasions.

In some aspects, the action comprises: determining whether the machine learning model output indicates a model variance event; sending, to the network entity, a baseline model output based on the received reference signal, if the machine learning model output indicates a model variance event; and sending, to the network entity, the machine learning model output, if the machine learning model output does not indicate a model variance event.

In some aspects, the method 1600 further includes receiving, from the network entity, a model failure information request. In some cases, the operations of this step refer to, or may be performed by, circuitry for receiving and/or code for receiving as described with reference to FIG. 18.

In some aspects, the method 1600 further includes sending, to the network entity, a model failure report. In some cases, the operations of this step refer to, or may be performed by, circuitry for sending and/or code for sending as described with reference to FIG. 18.

In some aspects, the method 1600 further includes receiving, from the network entity, an updated machine learning model. In some cases, the operations of this step refer to, or may be performed by, circuitry for receiving and/or code for receiving as described with reference to FIG. 18.

In some aspects, the machine learning model comprises a channel state feedback machine learning model, and the machine learning model output comprises channel state information feedback.

In some aspects, the machine learning model comprises a channel estimation machine learning model, and the machine learning model output comprises a channel estimate.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

### Example Operations of a Network Entity

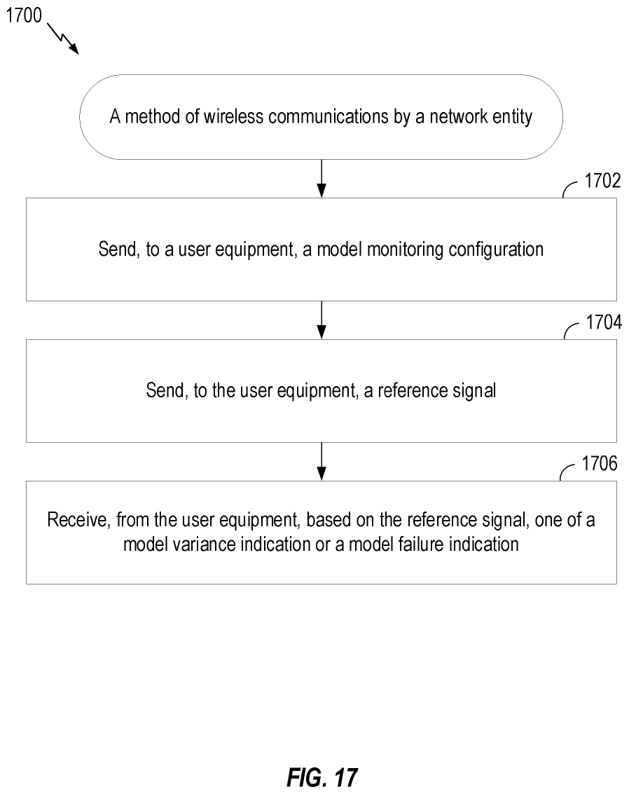

FIG. 17 shows an example of a method 1700 for wireless communications by a network entity, such as BS 102 of FIGS. 1 and 3, or a disaggregated base station as discussed with respect to FIG. 2.

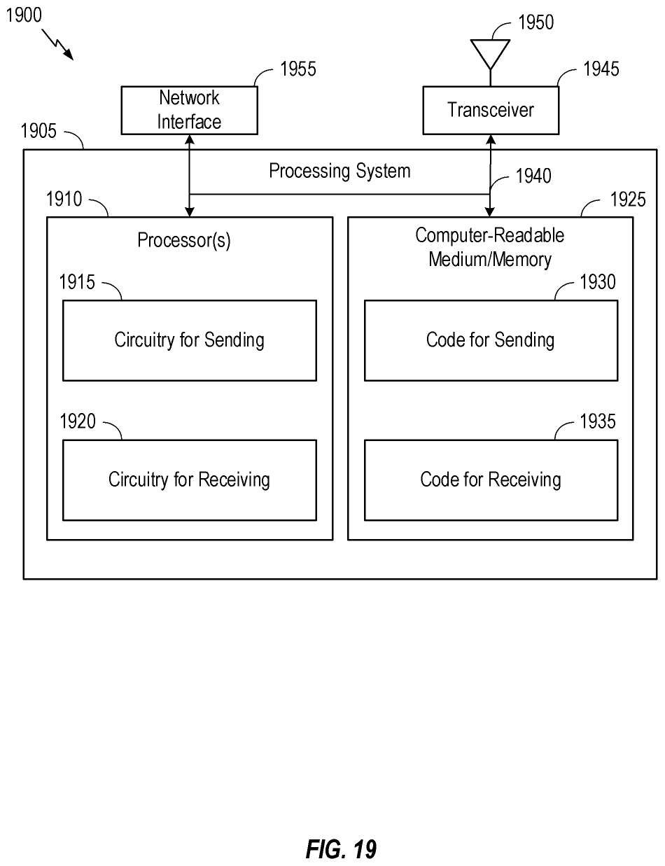

Method 1700 begins at step 1705 with sending, to a user equipment, a model monitoring configuration. In some cases, the operations of this step refer to, or may be performed by, circuitry for sending and/or code for sending as described with reference to FIG. 19.

Method 1700 then proceeds to step 1710 with sending, to the user equipment, a reference signal. In some cases, the operations of this step refer to, or may be performed by, circuitry for sending and/or code for sending as described with reference to FIG. 19.

Method 1700 then proceeds to step 1715 with receiving, from the user equipment, based on the reference signal, one of a model variance indication or a model failure indication. In some cases, the operations of this step refer to, or may be performed by, circuitry for receiving and/or code for receiving as described with reference to FIG. 19.

In some aspects, the model monitoring configuration defines a plurality of model monitoring states.

In some aspects, the method 1700 further includes sending, to the user equipment, a channel state information reporting configuration configured to cause the user equipment to enable a selected model monitoring state of the plurality of model monitoring states. In some cases, the operations of this step refer to, or may be performed by, circuitry for sending and/or code for sending as described with reference to FIG. 19.

In some aspects, each respective model monitoring state of the plurality of model monitoring states is associated with a respective mode flag, and the channel state information reporting configuration comprises a mode flag configured to cause the user equipment to enable the selected model monitoring state of the plurality of model monitoring states.

In some aspects, the method 1700 further includes sending, to the user equipment via RRC messaging, a mode flag configured to cause the user equipment to enable another model monitoring state of the plurality of model monitoring states. In some cases, the operations of this step refer to, or may be performed by, circuitry for sending and/or code for sending as described with reference to FIG. 19.

In some aspects, the method 1700 further includes sending, to the user equipment via one or more MAC-CEs, a mode flag configured to cause the user equipment to enable another model monitoring state of the plurality of model monitoring states. In some cases, the operations of this step refer to, or may be performed by, circuitry for sending and/or code for sending as described with reference to FIG. 19.

In some aspects, the method 1700 further includes sending, to the user equipment via DCI, a mode flag configured to cause the user equipment to enable another model monitoring state of the plurality of model monitoring states. In some cases, the operations of this step refer to, or may be performed by, circuitry for sending and/or code for sending as described with reference to FIG. 19.

In some aspects, the channel state information reporting configuration configures a first set of target CSI-RS resources and a second set of reference CSI-RS resources, each target CSI-RS resource in the first set of target CSI-RS resources is paired with a reference CSI-RS resource in the second set of reference CSI-RS resources, and the channel state information reporting configuration is configured to cause the user equipment to determine whether to measure the second set of reference CSI-RS resources based on the selected model monitoring state.

In some aspects, the channel state information reporting configuration comprises a mode flag configured to cause the user equipment to determine whether to measure the second set of reference CSI-RS resources based on the selected model monitoring state.

In some aspects, the method 1700 further includes sending, to the user equipment, a resource indication configured to cause the user equipment to determine whether to measure the second set of reference CSI-RS resources based on the selected model monitoring state. In some cases, the operations of this step refer to, or may be performed by, circuitry for sending and/or code for sending as described with reference to FIG. 19.

In some aspects, receiving, from the user equipment, one of the model variance indication or the model failure indication comprises receiving the model variance indication.

In some aspects, the method 1700 further includes sending, to the user equipment, an indication of a model failure event based at least in part on receiving the model variance indication. In some cases, the operations of this step refer to, or may be performed by, circuitry for sending and/or code for sending as described with reference to FIG. 19.

In some aspects, the indication of the model variance event is included in a report associated with a single model variance event.

In some aspects, the indication of the model variance event is included in a report associated with a plurality of model variance events occurring within a predetermined number of model variance event monitoring occasions.

In some aspects, receiving, from the user equipment, one of the model variance indication or the model failure indication comprises receiving the model failure indication.

In some aspects, the method 1700 further includes sending, to the user equipment, a model failure information request. In some cases, the operations of this step refer to, or may be performed by, circuitry for sending and/or code for sending as described with reference to FIG. 19.

In some aspects, the method 1700 further includes receiving, from the user equipment, a model failure report. In some cases, the operations of this step refer to, or may be performed by, circuitry for receiving and/or code for receiving as described with reference to FIG. 19.

In some aspects, the method 1700 further includes sending, to the user equipment, an updated machine learning model. In some cases, the operations of this step refer to, or may be performed by, circuitry for sending and/or code for sending as described with reference to FIG. 19.

In some aspects, the model monitoring configuration is associated with a channel state feedback machine learning model.

In some aspects, the model monitoring configuration is associated with a channel estimation machine learning model.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to the transceiver 1875 (e.g., a transmitter and/or a receiver). The transceiver 1875 is configured to transmit and receive signals for the communications device 1800 via the antenna 1880, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1840 via a bus 1870. In certain aspects, the computer-readable medium/memory 1840 is configured to store instructions (e.g., computer-executable code) that when executed by the one or more processors 1810, cause the one or more processors 1810 to perform the method 1600 described with respect to FIG. 16, or any aspect related to it. Note that reference to a processor performing a function of communications device 1800 may include one or more processors 1810 performing that function of communications device 1800.

In the depicted example, computer-readable medium/memory 1840 stores code (e.g., executable instructions), such as code for receiving 1845, code for processing 1850, code for determining 1855, code for activating 1860, and code for sending 1865. Processing of the code for receiving 1845, code for processing 1850, code for determining 1855, code for activating 1860, and code for sending 1865 may cause the communications device 1800 to perform the method 1600 described with respect to FIG. 16, or any aspect related to it.

The one or more processors 1810 include circuitry configured to implement (e.g., execute) the code stored in the computer-readable medium/memory 1840, including circuitry such as circuitry for receiving 1815, circuitry for processing 1820, circuitry for determining 1825, circuitry for activating 1830, and circuitry for sending 1835. Processing with circuitry for receiving 1815, circuitry for processing 1820, circuitry for determining 1825, circuitry for activating 1830, and circuitry for sending 1835 may cause the communications device 1800 to perform the method 1600 described with respect to FIG. 16, or any aspect related to it.

Various components of the communications device 1800 may provide means for performing the method 1600 described with respect to FIG. 16, or any aspect related to it. For example, means for transmitting, sending or outputting for transmission may include transceivers 354 and/or antenna(s) 352 of the UE 104 illustrated in FIG. 3 and/or the transceiver 1875 and the antenna 1880 of the communications device 1800 in FIG. 18. Means for receiving or obtaining may include transceivers 354 and/or antenna(s) 352 of the UE 104 illustrated in FIG. 3 and/or the transceiver 1875 and the antenna 1880 of the communications device 1800 in FIG. 18.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to the transceiver 1945 (e.g., a transmitter and/or a receiver) and/or a network interface 1955. The transceiver 1945 is configured to transmit and receive signals for the communications device 1900 via the antenna 1950, such as the various signals as described herein. The network interface 1955 is configured to obtain and send signals for the communications device 1900 via communication link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1925 via a bus 1940. In certain aspects, the computer-readable medium/memory 1925 is configured to store instructions (e.g., computer-executable code) that when executed by the one or more processors 1910, cause the one or more processors 1910 to perform the method 1700 described with respect to FIG. 17, or any aspect related to it. Note that reference to a processor of communications device 1900 performing a function may include one or more processors 1910 of communications device 1900 performing that function.

In the depicted example, the computer-readable medium/memory 1925 stores code (e.g., executable instructions), such as code for sending 1930 and code for receiving 1935. Processing of the code for sending 1930 and code for receiving 1935 may cause the communications device 1900 to perform the method 1700 described with respect to FIG. 17, or any aspect related to it.

The one or more processors 1910 include circuitry configured to implement (e.g., execute) the code stored in the computer-readable medium/memory 1925, including circuitry such as circuitry for sending 1915 and circuitry for receiving 1920. Processing with circuitry for sending 1915 and circuitry for receiving 1920 may cause the communications device 1900 to perform the method 1700 as described with respect to FIG. 17, or any aspect related to it.

Various components of the communications device 1900 may provide means for performing the method 1700 as described with respect to FIG. 17, or any aspect related to it. Means for transmitting, sending or outputting for transmission may include transceivers 332 and/or antenna(s) 334 of the BS 102 illustrated in FIG. 3 and/or the transceiver 1945 and the antenna 1950 of the communications device 1900 in FIG. 19. Means for receiving or obtaining may include transceivers 332 and/or antenna(s) 334 of the BS 102 illustrated in FIG. 3 and/or the transceiver 1945 and the antenna 1950 of the communications device 1900 in FIG. 19.

### Example Clauses

Implementation examples are described in the following numbered clauses:

Clause 1: A method of wireless communications by a user equipment, comprising: receiving, from a network entity, a reference signal; processing the reference signal with a machine learning model to generate machine learning model output; and determining an action to take based on the machine learning model output and a model monitoring configuration.

Clause 2: The method of Clause 1, further comprising receiving the model monitoring configuration from the network entity.

Clause 3: The method of any one of Clauses 1 and 2, wherein the model monitoring configuration defines a plurality of model monitoring states.

Clause 4: The method of Clause 3, further comprising receiving, from the network entity, a channel state information reporting configuration configured to cause the user equipment to enable a selected model monitoring state of the plurality of model monitoring states.

Clause 5: The method of Clause 4, wherein: each respective model monitoring state of the plurality of model monitoring states is associated with a respective mode flag, and the channel state information reporting configuration comprises a mode flag configured to cause the user equipment to enable the selected model monitoring state of the plurality of model monitoring states.

Clause 6: The method of Clause 4, further comprising receiving, from the network entity via RRC messaging, a mode flag configured to cause the user equipment to enable another model monitoring state of the plurality of model monitoring states.

Clause 7: The method of Clause 4, further comprising receiving, from the network entity via one or more MAC-CEs, a mode flag configured to cause the user equipment to enable another model monitoring state of the plurality of model monitoring states.

Clause 8: The method of Clause 4, further comprising receiving, from the network entity via DCI, a mode flag configured to cause the user equipment to enable another model monitoring state of the plurality of model monitoring states.

Clause 9: The method of Clause 4, wherein: the channel state information reporting configuration configures a first set of target CSI-RS resources and a second set of reference CSI-RS resources, each target CSI-RS resource in the first set of target CSI-RS resources is paired with a reference CSI-RS resource in the second set of reference CSI-RS resources, and the channel state information reporting configuration is configured to further cause the user equipment to determine whether to measure the second set of reference CSI-RS resources based on the selected model monitoring state.

Clause 10: The method of Clause 9, wherein the channel state information reporting configuration comprises a mode flag configured to cause the user equipment to determine whether to measure the second set of reference CSI-RS resources based on the selected model monitoring state.

Clause 11: The method of Clause 9, further comprising receiving, from the network entity, a resource indication configured to cause the user equipment to determine whether to measure the second set of reference CSI-RS resources based on the selected model monitoring state.

Clause 12: The method of Clause 3, further comprising activating a model monitoring state of the plurality of model monitoring states based on a predefined rule.

Clause 13: The method of any one of Clauses 1-12, wherein the action comprises sending the machine learning model output to the network entity.

Clause 14: The method of any one of Clauses 1-13, wherein the action comprises determining a model variance event based on the machine learning model output.

Clause 15: The method of Clause 14, wherein determining the model variance event comprises at least one of: determining statistics associated with the machine learning model output; processing the machine learning model output with a variance model configured to determine the model variance event; determining that an error metric associated with the machine learning model output is above a threshold; determining that the machine learning model output differs from a baseline model output by more than a threshold; or determining that an error metric associated with decoding performance at the user equipment is above a threshold.

Clause 16: The method of Clause 14, wherein the action further comprises sending, to the network entity, an indication of the model variance event.

Clause 17: The method of Clause 16, further comprising receiving, from the network entity, an indication of a model failure event associated with the machine learning model.

Clause 18: The method of Clause 16, wherein the indication of the model variance event is included in a report associated with a single model variance event.

Clause 19: The method of Clause 16, wherein the indication of the model variance event is included in a report associated with a plurality of model variance events occurring within a predetermined number of model variance event monitoring occasions.

Clause 20: The method of Clause 14, wherein the action further comprises: determining a model failure event based on the model variance event; and sending, to the network entity, an indication of the model failure event associated with the machine learning model.

Clause 21: The method of Clause 20, wherein determining the model failure event comprises: incrementing a model variance event counter value; and determining that the model variance event counter value exceeds a model variance event count threshold during a monitoring interval.

Clause 22: The method of Clause 21, wherein the monitoring interval comprises a model variance event reporting interval.

Clause 23: The method of Clause 21, wherein the monitoring interval comprises a predetermined number of channel state information reference signal occasions.

Clause 24: The method of any one of Clauses 1-23, wherein the action comprises: determining whether the machine learning model output indicates a model variance event; sending, to the network entity, a baseline model output based on the received reference signal, if the machine learning model output indicates a model variance event; and sending, to the network entity, the machine learning model output, if the machine learning model output does not indicate a model variance event.

Clause 25: The method of any one of Clauses 1-24, further comprising receiving, from the network entity, a model failure information request.

Clause 26: The method of Clause 25, further comprising sending, to the network entity, a model failure report.

Clause 27: The method of Clause 26, further comprising receiving, from the network entity, an updated machine learning model.

Clause 28: The method of any one of Clauses 1-27, wherein: the machine learning model comprises a channel state feedback machine learning model, and the machine learning model output comprises channel state information feedback.

Clause 29: The method of any one of Clauses 1-28, wherein: the machine learning model comprises a channel estimation machine learning model, and the machine learning model output comprises a channel estimate.

Clause 30: A method of wireless communications by a network entity, comprising: sending, to a user equipment, a model monitoring configuration; sending, to the user equipment, a reference signal; and receiving, from the user equipment, based on the reference signal, one of a model variance indication or a model failure indication.

Clause 31: The method of Clause 30, wherein the model monitoring configuration defines a plurality of model monitoring states.

Clause 32: The method of Clause 31, further comprising sending, to the user equipment, a channel state information reporting configuration configured to cause the user equipment to enable a selected model monitoring state of the plurality of model monitoring states.

Clause 33: The method of Clause 32, wherein: each respective model monitoring state of the plurality of model monitoring states is associated with a respective mode flag, and the channel state information reporting configuration comprises a mode flag configured to cause the user equipment to enable the selected model monitoring state of the plurality of model monitoring states.

Clause 34: The method of Clause 32, further comprising sending, to the user equipment via RRC messaging, a mode flag configured to cause the user equipment to enable another model monitoring state of the plurality of model monitoring states.

Clause 35: The method of Clause 32, further comprising sending, to the user equipment via one or more MAC-CEs, a mode flag configured to cause the user equipment to enable another model monitoring state of the plurality of model monitoring states.

Clause 36: The method of Clause 32, further comprising sending, to the user equipment via DCI, a mode flag configured to cause the user equipment to enable another model monitoring state of the plurality of model monitoring states.

Clause 37: The method of Clause 32, wherein: the channel state information reporting configuration configures a first set of target CSI-RS resources and a second set of reference CSI-RS resources, each target CSI-RS resource in the first set of target CSI-RS resources is paired with a reference CSI-RS resource in the second set of reference CSI-RS resources, and the channel state information reporting configuration is configured to cause the user equipment to determine whether to measure the second set of reference CSI-RS resources based on the selected model monitoring state.

Clause 38: The method of Clause 37, wherein the channel state information reporting configuration comprises a mode flag configured to cause the user equipment to determine whether to measure the second set of reference CSI-RS resources based on the selected model monitoring state.

Clause 39: The method of Clause 32, further comprising sending, to the user equipment, a resource indication configured to cause the user equipment to determine whether to measure the second set of reference CSI-RS resources based on the selected model monitoring state.

Clause 40: The method of any one of Clauses 30-39, wherein receiving, from the user equipment, one of the model variance indication or the model failure indication comprises receiving the model variance indication.

Clause 41: The method of Clause 40, further comprising sending, to the user equipment, an indication of a model failure event based at least in part on receiving the model variance indication.

Clause 42: The method of Clause 41, wherein the indication of the model variance event is included in a report associated with a single model variance event.

Clause 43: The method of Clause 41, wherein the indication of the model variance event is included in a report associated with a plurality of model variance events occurring within a predetermined number of model variance event monitoring occasions.

Clause 44: The method of any one of Clauses 30-43, wherein receiving, from the user equipment, one of the model variance indication or the model failure indication comprises receiving the model failure indication.

Clause 45: The method of any one of Clauses 30-44, further comprising sending, to the user equipment, a model failure information request.

Clause 46: The method of Clause 45, further comprising receiving, from the user equipment, a model failure report.

Clause 47: The method of Clause 46, further comprising sending, to the user equipment, an updated machine learning model.

Clause 48: The method of any one of Clauses 30-47, wherein the model monitoring configuration is associated with a channel state feedback machine learning model.

Clause 49: The method of any one of Clauses 30-48, wherein the model monitoring configuration is associated with a channel estimation machine learning model.

Clause 50: An apparatus, comprising: a memory comprising executable instructions; and a processor configured to execute the executable instructions and cause the apparatus to perform a method in accordance with any one of Clauses 1-49.

Clause 51: An apparatus, comprising means for performing a method in accordance with any one of Clauses 1-49.

Clause 52: A non-transitory computer-readable medium comprising executable instructions that, when executed by a processor of an apparatus, cause the apparatus to perform a method in accordance with any one of Clauses 1-49.

Clause 53: A computer program product embodied on a computer-readable storage medium comprising code for performing a method in accordance with any one of Clauses 1-49.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications by a user equipment (UE), comprising:
one or more memories comprising executable instructions; and
one or more processors configured to execute the executable instructions and cause the UE to:
receive from a network entity, a reference signal;
process the reference signal with a machine learning model to generate machine learning model output; and
determine an action to take based on the machine learning model output and a model monitoring configuration.

2. The apparatus of claim 1, wherein the one or more processors are further configured to execute the executable instructions and cause the UE to receive the model monitoring configuration from the network entity.

3. The apparatus of claim 1, wherein the model monitoring configuration defines a plurality of model monitoring states.

4. The apparatus of claim 3, wherein the one or more processors are further configured to execute the executable instructions and cause the UE to receive, from the network entity, a channel state information reporting configuration configured to cause the user equipment to enable a selected model monitoring state of the plurality of model monitoring states.

5. The apparatus of claim 4, wherein:
each respective model monitoring state of the plurality of model monitoring states is associated with a respective mode flag, and
the channel state information reporting configuration comprises a mode flag configured to cause the user equipment to enable the selected model monitoring state of the plurality of model monitoring states.

6. The apparatus of claim 1, wherein the action comprises sending the machine learning model output to the network entity.

7. The apparatus of claim 1, wherein the action comprises determining a model variance event based on the machine learning model output.

8. The apparatus of claim 7, wherein determining the model variance event comprises at least one of:
determining statistics associated with the machine learning model output;
processing the machine learning model output with a variance model configured to determine the model variance event;
determining that an error metric associated with the machine learning model output is above a threshold;
determining that the machine learning model output differs from a baseline model output by more than a threshold; or
determining that an error metric associated with decoding performance at the user equipment is above a threshold.

9. The apparatus of claim 7, wherein the action further comprises sending, to the network entity, an indication of the model variance event.

10. The apparatus of claim 9, wherein the one or more processors are further configured to execute the executable instructions and cause the UE to receive, from the network entity, an indication of a model failure event associated with the machine learning model.

11. The apparatus of claim 9, wherein the indication of the model variance event is included in a report associated with a single model variance event.

12. The apparatus of claim 9, wherein the indication of the model variance event is included in a report associated with a plurality of model variance events occurring within a predetermined number of model variance event monitoring occasions.

13. The apparatus of claim 7, wherein the action further comprises:
determining a model failure event based on the model variance event; and
sending, to the network entity, an indication of the model failure event associated with the machine learning model.

14. The apparatus of claim 13, wherein determining the model failure event comprises:
incrementing a model variance event counter value; and
determining that the model variance event counter value exceeds a model variance event count threshold during a monitoring interval.

15. The apparatus of claim 14, wherein the monitoring interval comprises a model variance event reporting interval.

16. The apparatus of claim 14, wherein the monitoring interval comprises a predetermined number of channel state information reference signal occasions.

17. The apparatus of claim 1, wherein the action comprises:
determining whether the machine learning model output indicates a model variance event;
sending, to the network entity, a baseline model output based on the received reference signal, if the machine learning model output indicates a model variance event; and
sending, to the network entity, the machine learning model output, if the machine learning model output does not indicate a model variance event.

18. The apparatus of claim 4, wherein the one or more processors are further configured to execute the executable instructions and cause the UE to receive, a mode flag configured to cause the user equipment to enable another model monitoring state of the plurality of model monitoring states.

19-20. (canceled)

21. The apparatus of claim 3, wherein the one or more processors are further configured to execute the executable instructions and cause the UE to activate a model monitoring state of the plurality of model monitoring states based on a predefined rule.

22. The apparatus of claim 4, wherein:
the channel state information reporting configuration configures a first set of target channel state information reference signal (CSI-RS) resources and a second set of reference CSI-RS resources,
each target CSI-RS resource in the first set of target CSI-RS resources is paired with a reference CSI-RS resource in the second set of reference CSI-RS resources, and
the channel state information reporting configuration is configured to further cause the user equipment to determine whether to measure the second set of reference CSI-RS resources based on the selected model monitoring state.

23. The apparatus of claim 22, wherein the channel state information reporting configuration comprises a mode flag configured to cause the user equipment to determine whether to measure the second set of reference CSI-RS resources based on the selected model monitoring state.

24. The apparatus of claim 22, wherein the one or more processors are further configured to execute the executable instructions and cause the UE to receive, from the network entity, a resource indication configured to cause the user equipment to determine whether to measure the second set of reference CSI-RS resources based on the selected model monitoring state.

25. The apparatus of claim 1, wherein the one or more processors are further configured to execute the executable instructions and cause the UE to receive, from the network entity, a model failure information request.

26. The apparatus of claim 25, wherein the one or more processors are further configured to execute the executable instructions and cause the UE to send, to the network entity, a model failure report.

27. The apparatus of claim 26, wherein the one or more processors are further configured to execute the executable instructions and cause the UE to receive, from the network entity, an updated machine learning model.

28. The apparatus of claim 1, wherein:
the machine learning model comprises a channel state feedback machine learning model, and
the machine learning model output comprises channel state information feedback.

29. The apparatus of claim 1, wherein:
the machine learning model comprises a channel estimation machine learning model, and
the machine learning model output comprises a channel estimate.

30. An apparatus for wireless communications by a network entity, comprising:
one or more memories comprising executable instructions; and
one or more processors configured to execute the executable instructions and cause the UE to:
send to a user equipment, a model monitoring configuration;
send, to the user equipment, a reference signal; and
receive, from the user equipment, based on the reference signal, one of a model variance indication or a model failure indication.

31-53. (canceled)

54. A method of wireless communications by a user equipment, comprising:
receiving from a network entity, a reference signal;
processing the reference signal with a machine learning model to generate machine learning model output; and
determining an action to take based on the machine learning model output and a model monitoring configuration.
